(19) United States
(12) Patent Application Publication
(10) Pub. No.: US 2017/0330422 A1
(43) Pub. Date: Nov. 16, 2017

(54) DERBY RACING GAME

(71) Applicant: Mark Hamilton Jones and Sheryl Lynn Jones Family Trust Dated November 7, 2013, Gardnerville, NV (US)

(72) Inventor: Mark H. Jones, Gardnerville, NV (US)

(21) Appl. No.: 15/593,699

(22) Filed: May 12, 2017

Related U.S. Application Data
(60) Provisional application No. 62/335,220, filed on May 12, 2016.

(51) Int. Cl. G07F 17/32

(52) U.S. Cl. CPC G07F 17/3286; G07F 17/3244; G07F 17/3211; G07F 17/322

(57) ABSTRACT

A racing game may be played as a table game, and/or with electronic enhancements and includes a race course with a plurality of lanes arranged concentrically and divided into segments, with each of the lanes having the same number of segments. A gamepiece is movable about each of the lanes in a race from an initial position until a winning one of the gamepieces first crosses a finish line. Randomizers select one of the gamepieces to be moved, and the number of segments to move. A payout is provided as a multiplier of a base wager placed on the winning one of the gamepieces. A method of play is also provided and includes a side-bet between players and additional, optional bets for short and long games which provide a return that varies depending on the number of rolls in a race.

### CROSS REFERENCE TO RELATED APPLICATION

This application claims the benefit of U.S. Provisional Application Ser. No. 62/335,220 filed May 12, 2016, which is incorporated herein by reference in its entirety.

### TECHNICAL FIELD

The present disclosure relates generally to a game of chance. More specifically, the present disclosure relates to a game and method of gameplay for a racing game of chance.

### BACKGROUND OF THE DISCLOSURE

Games of chance are well-known activities whose outcomes are strongly influenced by randomizing devices and upon which contestants may wager money as they forecast outcomes. Games of chance have been played throughout all of human history, and are considered popular pastimes by many. Players of games of chance are attracted to new and exciting methods of game play. Therefore, there remains a need for new and interesting method and system for playing games of chance that maintain player interest and attract new players.

### SUMMARY OF THE INVENTION

According to an aspect of the disclosure, a racing game includes a race course including a plurality of lanes arranged generally concentrically and divided into a plurality of segments, with each of the lanes having the same number of segments. A finish line may be associated with one of a last one of the segments. A gamepiece may be disposed upon and movable about each of the lanes in a race from an initial position on a first one of the segments until one of the gamepieces first crosses the finish line and is thereby designated as a winning one of the gamepieces. A first randomizer may determine a selected one of the gamepieces to be moved, and a second randomizer independent of the first randomizer can determine a number of segments the selected one of the gamepieces is to move. A wagering area corresponding to each of said gamepieces may be provided for placement of a base wager, which may result in a payout calculated by multiplying a payout multiplier by each of the base wagers placed on the wagering area corresponding to the winning one of the gamepieces.

According to another aspect of the disclosure, a method for playing a racing game of chance is also disclosed. The method may include the steps of providing a race course including a plurality of lanes each divided into an equal plurality of segments and a gamepiece associated with each of said lanes; placing a base wager by a player upon one of the gamepieces; placing the gamepieces in an initial segment of the race course and with each of the gamepieces in an associated lane; and conducting a plurality of rolls until one of the gamepieces is determined to be the winner. Each roll may include the substeps of: selecting using a first randomizer a gamepiece to move, selecting using a second randomizer a number of segments the gamepiece is to move, and moving the gamepiece selected by the first randomizer by a number of segments as indicated by the second randomizer. The method may proceed with the steps of determining after a roll is complete whether the selected gamepiece is a winner having moved beyond a finish line on the race course; determining the payout for each of the base wagers associated with the winner as the base wager times a payout multiplier; collecting the base wagers associated with the gamepieces not identified as the winner; and distributing the payout corresponding to each of the base wagers associated with the winner.

### BRIEF DESCRIPTION OF THE DRAWINGS

Other aspects of the present disclosure will be readily appreciated, as the same becomes better understood by reference to the following detailed description when considered in connection with the accompanying drawings wherein:

FIG. 1 is a top view of a table game with playing surface that includes a plain background;

FIG. 2 is a top view of a table game with a playing surface that includes a decorative graphic background;

FIG. 3 is a perspective view of a table game with a pair of blower units, each filled with numbered balls;

FIG. 4 is an enlarged perspective view of two betting positions with a gamepiece placed thereupon and a wagering chip placed on wagering area “5”;

FIG. 5 is an enlarged perspective view of the race course portion of a table game;

FIG. 6 is a block diagram of components according to an aspect of the disclosure;

FIG. 7 is a flow chart for a method for playing a racing game of chance according to an aspect of the present disclosure;

FIG. 8 is a flow chart for a method for playing a racing game of chance according to an aspect of the present disclosure;

FIG. 9 is a flow chart for an additional method for playing a racing game of chance according to an aspect of the present disclosure; and

FIG. 10 is a flow chart for an additional method for playing a racing game of chance according to an aspect of the present disclosure.

### DESCRIPTION OF THE ENABLING EMBODIMENT

Referring to the Figures, wherein like numerals indicate corresponding parts throughout the several views, a table game is disclosed. More particularly, the present disclosure relates to a racing game 20 including a race course 22 that determines an outcome of a game of chance.

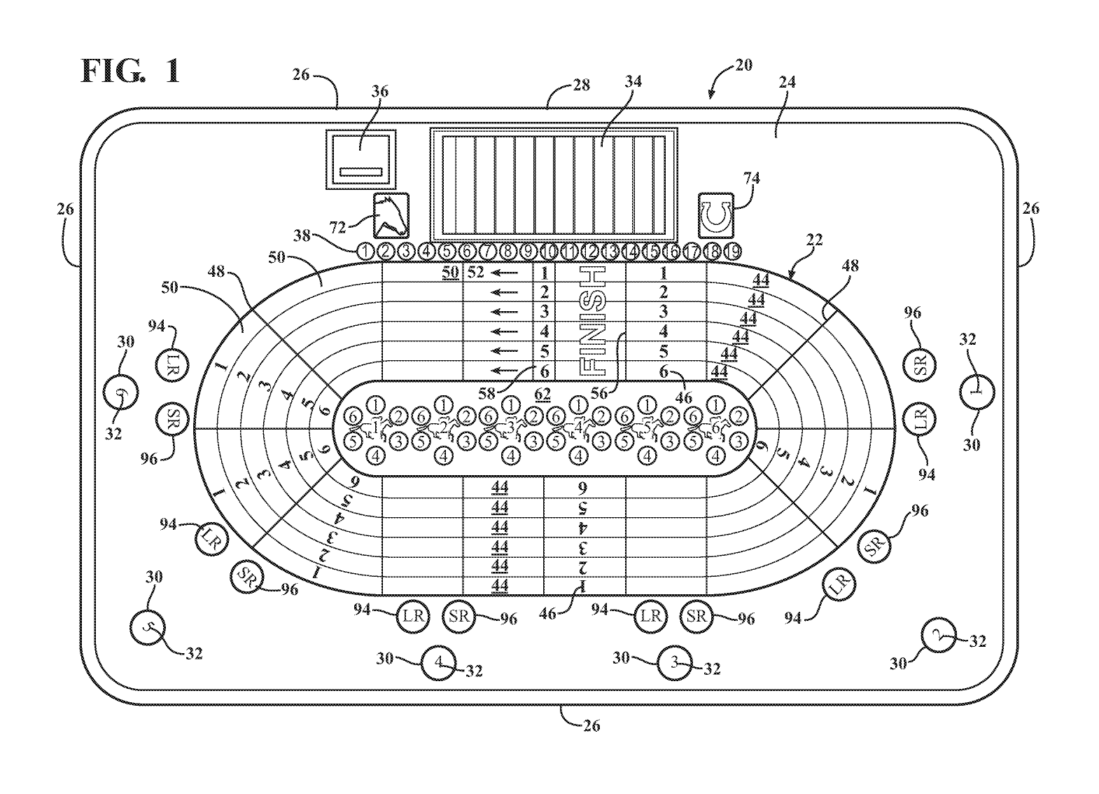

According to an aspect as best shown in FIG. 1, the racing game 20 may be provided as a table game including a playing surface 24 having a generally rectangular shape with four edges 26 with a dealer position 28 at the center of one of the edges 26 and with a plurality of player positions 30 regularly spaced about the remaining ones of the edges 26. Each of the player positions 30 may have a second indicia 32 which may be a number 1-6. A variety of other indicia may also be employed. A chip tray 34 may be inset in the playing surface 24 adjacent the dealer position 28. A cash box 36 may be inset in the playing surface 24 proximate to the dealer position 28. A roll number indicator 38 may be provided as a plurality of numbered circles for indicating the number of rolls completed. The roll number indicator may provide useful information to the dealer, players, and/or others such as casino management and security personnel to determine how many rolls have been completed at any given time and/or how many total rolls were completed in any given race. The number of rolls completed in a given race may impact one or more aspects of the racing game 20 according to the present disclosure.

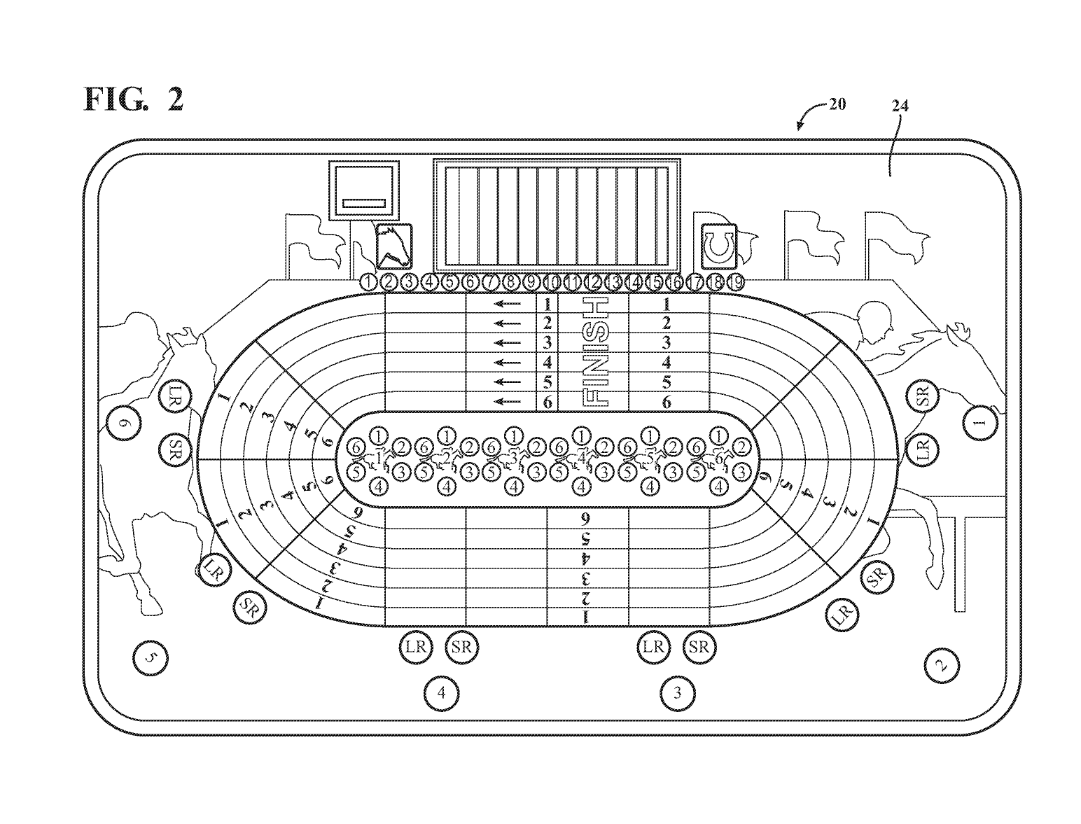

The playing surface 24 may include a background 37 that includes graphics or indicia to guide gameplay or as a decorative theme, such as the horse racing graphic shown in FIG. 2. The background 37 of the playing surface 24 may also be a solid color, such as shown in FIG. 1. The playing surface 24 may be adapted to other table shapes or configurations and may be fitted to new or pre-existing tables used in casino gaming, such as a blackjack table, craps tub, poker table, or any other shape or configuration.

According to an aspect, and as shown in FIGS. 1 and 2, the racing game 20 may include a race course 22 which may be centrally located on the playing surface 24 and which may have a generally oval shape with straight sections between semicircular ends. The race course 22 may include a plurality of lanes 44 arranged generally concentrically, and each lane 44 may be identified by a first indicia 46 such as a number 1-6, as shown in FIG. 1. A plurality of radial lines 48 may divide each of the lanes 44 into a plurality of segments 50, with each of the lanes 44 having the same number of segments 50. A first one 52 of the segments 50 may include a “START” indicia to demark the beginning and a last one 54 of the segments 50 may include a “FINISH” indicia to demark the finish line 56 of the race course 22. The “START” indicia and/or the “FINISH” indicia may be symbolic or graphic, such as, for example, a starting gate and a checkered flag. The race course 22 may also include a winner's position 58 associated with each of the lanes 44, which may be located immediately between the first one 52 of the segments 50 and the last one 54 of the segments 50. The winner's position 58 may also include the first indicia 46 to identify each of the lanes 44, as shown in FIGS. 1-2. A gamepiece 60, which may be stylized as a racehorse, such as, for example, by shape or coloration, may be disposed upon each of the lanes 44. The gamepieces 60 may be have other forms including, for example, cars, trucks, chariots, people, or dogs or other animals.

According to an aspect, the playing surface 24 may also include an infield area 62 in the central area of the race course 22 with a plurality of betting positons 64 equal in number to the lanes 44 and each having one of the first indicia 46 matching a corresponding one of the lanes 44. A plurality of wagering areas 66 may be provided around each of the betting positons 64 equal in number to the player positions 30 for placement of a base wager and an optional side wager by the player in the associated player position 30. Each of the wagering areas 66 may be marked, such as with the second indicia 32, to correlate with a corresponding one of the player positions 30.

According to an aspect, and as best shown in FIGS. 1-2, a first randomizer 72, which may be a card shuffler with a first deck of cards, may be disposed proximate the dealer position 28 such as at the dealer's right hand side. The first randomizer 72 may designate a gamepiece 60 to move. In the example of the first randomizer 72 including a first deck of cards, the first deck of cards may be designated “horse cards” and the act of designating a gamepiece 60 to move may include drawing by the dealer a “horse card” from the first deck of cards with the “horse card” drawn indicating which of the gamepieces 60 to move. According to an aspect, a second randomizer 74, which may be a card shuffler with a second deck of cards, may be disposed proximate the dealer position 28 such as at the dealer's left hand side. The second randomizer 74 may designate a number of segments 50 the selected gamepiece 60 is to move. The second randomizer 74 may be independent of the first randomizer 72, meaning that the outcome of the second randomizer 74 is not affected by the outcome of the first randomizer 72. In the example of the second randomizer 74 including a second deck of cards, the second deck of cards may be designated “advancement cards” and the act of determining the number of segments 50 to move may include drawing by the dealer an “advancement card” from the second deck of cards with the “advancement card” drawn indicating the number of segments 50 for the designated gamepiece 60 to move.

According to an aspect, each of the two decks of cards may have six cards. The two decks of cards may each have a different colored backing or be otherwise visibly distinguishable from one another. According to another aspect, a single deck of cards may be used that includes both the “horse cards” and the “advancement cards.” Additional decks of cards may be pre-shuffled and ready to use when the cards of the first deck or the cards of the second deck have all been dealt. In other words, the race may continue without the need for a delay to reshuffle either of the decks of cards.

It should be appreciated that any other means of randomly selecting one of the gamepieces 60 and one of the numbers of positions to move, and/or any combination thereof may be used in place of the two decks of cards. Examples include, but are not limited to the use of blower units each seplurality of balls, dice, computerized random number generator (RNG) device or devices, or any other means of randomized selection. Such randomized selection devices may be restricted or dictated by applicable jurisdictional gaming laws.

According to an aspect, the subject racing game 20 may also be configured in a semi-automated format. In such a semi-automated format, card draws may be electronically selected and displayed. According to an aspect, in a semi-automated format the gamepiece 60 may be moved electronically. According to another aspect, the subject racing game 20 may be entirely electronic and may include a video display 88 and a user input device 90 for allowing a player to interact with said racing game 20 and to select one or more of said gamepieces 60 to wager upon. The user input device 90 may include, for example, one or more pushbuttons, a touchscreen, a keyboard, mouse, trackpad, or a combination of one or more such devices.

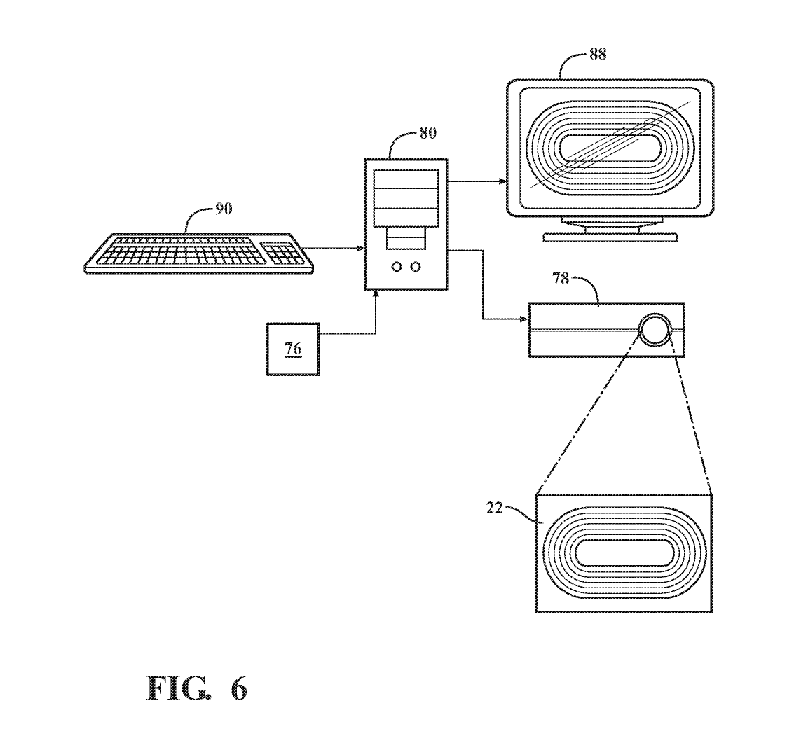

According to another aspect, and as best shown in FIG. 6, the subject racing game 20 may be played as a dealer-assisted electronic table game. Such a dealer-assisted electronic table game may include a digital reader 76 for determining the result of each of the randomizers 72, 74, a projector 78 for selectively illuminating a destination one of the segments 50 where a selected one of the gamepieces 60 is to move. A dealer-assisted electronic table game may also include a video display 88. A digital processor 80 may be operatively disposed between the digital reader 76 and the projector 78 for directing the projector 78 based on the state of the racing game 20 and on the result of each of the randomizers 72, 74 in a given roll. Variations of the dealer-assisted electronic table game may be provided in which the digital processor 80 includes a random number generator (RNG), which is used for one or more of the randomizers 72, 74. According to another variation of the dealer-assisted electronic table game, the gamepieces 60 may exist only as projected light from the projector 78 and/or as images on a video display 88, and gameplay may be conducted without physical gamepieces 60 being moved about the race course 22. A history of each game may be stored by the digital processor 80 for review during or after the game.

According to an aspect, there may be only one winning gamepiece 60. According to another aspect, there may be more than one winning gamepiece 60, which may include a second place, third place, etc. In other words, there may be prizes or a portion of the winnings allocated to the player who picks gamepieces 60 that finish the race first, second, third, or a combination thereof. According to an aspect, the race game may be completed after a single lap around the race course 22 from the first one 52 of the segments 50 to the finish line 56. Alternatively, the race game may require more than one lap around the race course 22 before a winner is determined. According to a further aspect, the beginning and the finish line 56 may be combined into a single start/finish line 56.

According to an aspect shown in FIGS. 1-2, the race course 22 may include six gamepieces 60, with a single gamepiece 60 in each lane 44. The gamepieces 60 may be initially positioned in the first one 52 of the segments 50. According to an aspect, players may wager on any number of the gamepieces 60 to win the race as a chosen gamepiece 60. Players may place a wager, which may be in the form of one or more chips, in the wagering area 66 that corresponds with that player's player position 30 and adjacent the betting position that corresponds with the chosen gamepiece 60. According to an aspect, all wagers must be placed before the race is begun. The dealer may announce that the race is to begin and that all wagering must cease. The dealer may also signal that no more wagers are available by switching an indicating device (not shown), which may be a game puck that is flipped-over to show “On” and “Off” positions.

According to an aspect, the dealer may singulate a card from the first deck to select a gamepiece 60 to move. The dealer may also singulate a card from the second deck to select the number of positions or segments 50 for the selected gamepiece 60 to move. The dealer may then cause the selected gamepiece 60 to advance around the race course 22 in its designated lane 44 by the selected number of segments 50. The advancement of the gamepiece 60 may be done in a counterclockwise direction to mimic the action of a horse racing derby. If, after causing the gamepiece 60 to advance, no gamepiece 60 has reached the last one 54 of the segments 50, the dealer may repeat the steps of singulating from each of the card decks and causing the gamepiece 60 to advance around the race course 22.

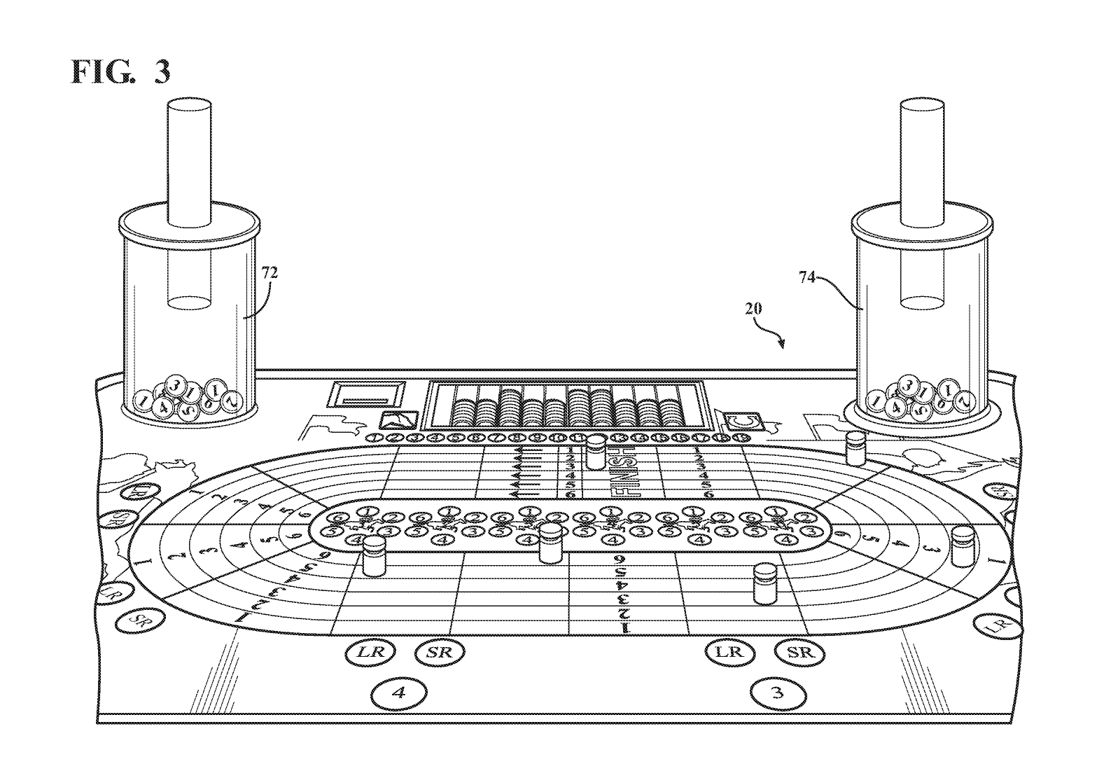

According to an alternative aspect, and as shown in FIG. 3, the dealer may singulate one or more balls from a first blower unit to select a gamepiece 60 to move. The dealer may also singulate one or more balls from a second blower unit to select the number of positions or segments 50 for the selected gamepiece 60 to move. The second deck or the second blower unit may be provided without cards or balls having low numbers such as 1 or 2. In this way, each time a card or ball is drawn, the respective gamepiece 60 will move a minimum of segments 50, which will greatly reduce the time needed to complete a race.

According to an aspect, if a given gamepiece 60 is the first to reach the last one 54 of the segments 50, that gamepiece 60 is designated as the winner and each player who had wagered upon the winner may share a given portion of the wagers placed on gamepieces 60 that were not the first to reach the last one 54 of the segments 50. According to an aspect, when a winner has been decided, the race is deemed to be ended and the dealer will then collect the wagers placed upon the non-winner gamepieces 60 and disburse the proceeds to the players who placed wagers on the winner gamepiece 60. Once the proceeds are disbursed, the dealer may return all gamepieces 60 to the first one 52 of the segments 50, or the starting line. The dealer may indicate that wagering is now open and may switch the indicating device to signal the same.

According to an aspect, if a gamepiece 60 is the first to reach the last one 54 of the segments 50 and there were no wagers associated with that gamepiece 60, the dealer may move that gamepiece 60 to the winner's position 58 and continue gameplay with the remaining gamepieces 60 until a gamepiece 60 that has been wagered upon is the first to reach the last one 54 of the segments 50, and that gamepiece 60 is designated as the winner for purposes of disbursing the proceeds as a prize to the player or players who wagered upon the winner. According to an alternative aspect, if a card is singulated that corresponds to a gamepiece 60 that does not have any wagers therewith, the dealer may continue singulating cards from the first deck to select another gamepiece 60 to move until a card is singulated that corresponds with a gamepiece 60 that has been wagered upon. In this way, only gamepieces 60 that have been wagered upon may advance around the race course 22.

According to an aspect, the racing game 20 may be played as a “minimal limit game.” In other words, a predetermined minimum bet is all that is required to be wagered. The playing surface 24 may include one or more wagering areas 66 corresponding to each of the gamepieces 60 for placement of a base wager. Each player who placed a base wager upon the winning one of the gamepieces 60, also called the winner, may receive a prize that is proportionate to the amount the base wager that player placed upon the winner. According to an aspect, the racing game 20 may provide a payout as a payout multiplier times each of the base wagers placed on the wagering area 66 corresponding to the winner. According to an aspect, the house may charge a collection fee from each player to cover its costs. According to an aspect, each player may bet on as many gamepieces 60 as they wish. According to an alternate aspect, each player may not bet on more than half of the gamepieces 60 in any given race.

According to an aspect, the racing game 20 may include a second place one of the gamepieces 60 as one of the gamepieces 60 other than the winner and which is closest to the finish line 56 at the time that the winner crosses the finish line 56, and with the winner having a lead as the number of segments 50 that the second place one of the gamepieces 60 is to the finish line 56. The racing game 20 may provide a payout multiplier that varies between two or more different values depending on the lead. In other words, a base wager upon a given gamepiece 60 may provide a first payout if that given gamepiece 60 wins by a lead less than a predetermined number of segments 50, and that same base wager upon the same given gamepiece 60 may provide a second payout different from the first payout if that given gamepiece 60 wins by a lead greater than or equal to the predetermined number of segments 50. The second payout may be higher than or less than the first payout. For example, the racing game 20 may provide a first payout based on a payout multiplier of 4:1 if the winner wins by a lead of less than 7 segments, and may provide a second payout based on a payout multiplier of 8:1 if the winner wins by a lead of 8 or more segments.

According to a further aspect, a player may place a second wager, which may be designated as a side wager, against one or more other players. The side wagers may be acted upon by the dealer at the end 42 of each race and before calculating the proceeds to be disbursed to the players based upon their base wagers. A base wager that is equal to or greater than the designated predetermined minimum bet amount may be required to be placed upon each gamepiece 60 upon which a player also places a side wager. In other words, a player must place a base wager upon a given gamepiece 60 to be eligible to place a side wager upon that same given gamepiece 60. Side wagers may also be placed having different values. Each of the side wagers at each given value may be pooled separately and paid to one of the players who placed a wide wager at that same given value. A side wager may require two or more players to wager the same value. If a player posts a side wager at any given dollar amount and no other players place side wagers for the same dollar amount, that side wager may be returned to the player.

According to an aspect, the dealer may only disburse winnings in predetermined increments, such as whole dollars. In disbursing the proceeds, there may be a remainder amount that cannot be disbursed evenly between winners using the predetermined increments. In this case, the remainder amount may carry-over and be added to the winning pool for the next race. A remainder amount that cannot be disbursed evenly between winners using the predetermined increments may also be retained by the house.

According to an aspect, the rules that govern the method of gameplay may be different depending on the number of players. In other words, one set of rules may be used on a short field with, for example, three or fewer players; another set of rules may be used with four or more players.

According to an aspect, the racing game 20 may provide for a long-race wager, which may be separate and independent from any other wager, and which may provide a long-race payout having a multiplier value that varies depending on the number of rolls or play turns before a gamepiece 60 is declared the winner, and which may also be called the “Race Length”. A player may be required to place a base wager upon one or more gamepieces 60 to be eligible to place a short-race wager. The long-race wager may, for example, provide a long-race payout as a multiple of the long-race wager according to the paytable shown in Table 1, below. A version of Table 1 may be displayed on the playing surface 24.

TABLE 1

| Race Length | Payout |
|---|---|
| 11 or Fewer Rolls | Loss |
| 12 Rolls | 2 to 1 |
| 13 Rolls | 2 to 1 |
| 14 Rolls | 3 to 1 |
| 15 Rolls | 5 to 1 |
| 16 Rolls | 10 to 1 |
| 17 Rolls | 15 to 1 |
| 18 Rolls | 25 to 1 |
| 19 Rolls | 100 to 1 |

According to an aspect, the racing game 20 may provide for a short-race wager, which may be separate and independent from any other wager, and which may provide a short-race payout having a multiplier value that varies depending on the number of rolls or play turns before a gamepiece 60 is declared the winner, and which may also be called the “Race Length”. A player may be required to place a base wager upon one or more gamepieces 60 to be eligible to place short-race wager. The short-race wager may, for example, provide a short-race payout as a multiple of the short-race wager according to the paytable shown in Table 2, below. A version of Table 2 may be displayed on the playing surface 24.

| Race Length | Payout |
|---|---|
| 3 Rolls | 10 to 1 |
| 4 Rolls | 5 to 1 |
| 5 Rolls | 3 to 1 |
| 6 Rolls | 2 to 1 |
| 7 Rolls | 1 to 1 |
| 8 or More Rolls | Loss |

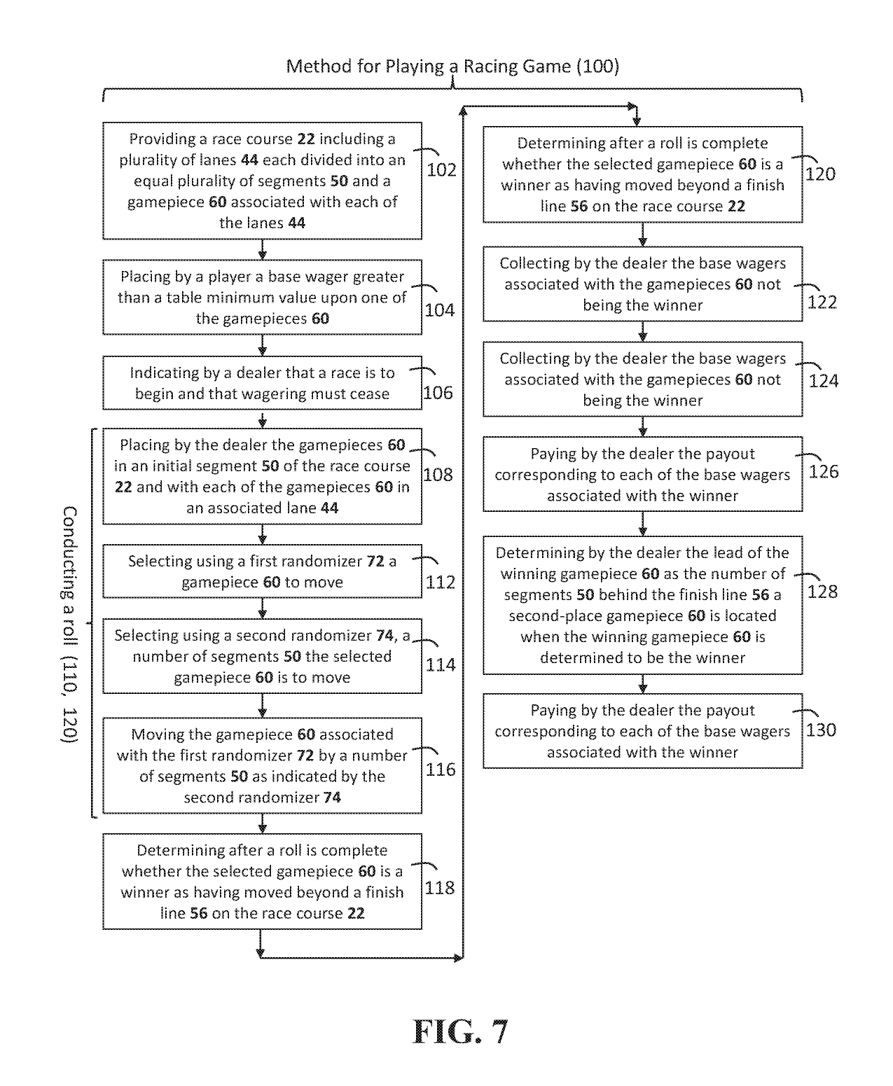

A method 100 for playing a racing game 20 of chance is also disclosed and described in the flow chart of FIG. 7. The method 100 comprises the steps of 102 providing a race course 22 including a plurality of lanes 44 each divided into an equal plurality of segments 50 and a gamepiece 60 associated with each of the lanes 44; 104 placing by a player a base wager greater than a table minimum value upon one of the gamepieces 60. In the case of the racing game 20 being provided as a table game, the step of 104 wagering may be performed by placing a wagering chip upon a wagering area 66 associated with the one of the gamepieces 60. Other means of wagering may also be performed such that an amount to be wagered is associated with one or more of the gamepieces 60. The method 100 may proceed with the steps of 106 indicating by a dealer that a race is to begin and that wagering must cease; 108 placing by the dealer the gamepieces 60 in an initial segment 50 of the race course 22 and with each of the gamepieces 60 in an associated lane 44; and 110 conducting by the dealer a roll to advance one of the gamepieces 60 along said race course 22.

The step of 110 conducting by the dealer a roll may include the substeps of 112 selecting using a first randomizer 72 a gamepiece 60 to move. The first randomizer 72 may be a card drawn from a first shuffler; and 114 selecting using a second randomizer 74, a number of segments 50 the selected gamepiece 60 is to move. The second randomizer 74 may be a card drawn card from a second shuffler. The step of 110 conducting a roll may continue with the substeps of 116 moving the gamepiece 60 associated with the first randomizer 72 by a number of segments 50 as indicated by the second randomizer 74.

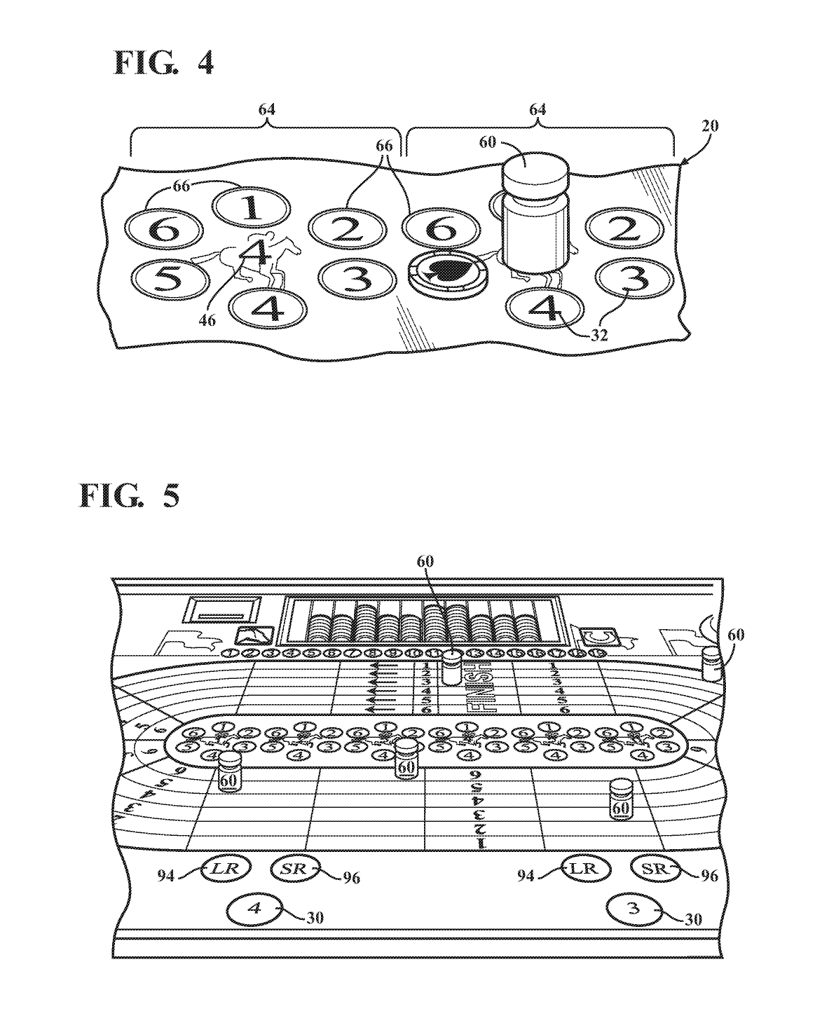

The method 100 may proceed with the step of 118 determining after a roll is complete whether the selected gamepiece 60 is a winner as having moved beyond a finish line 56 on the race course 22. The method 100 may include 120 repeating by the dealer the step of 110 conducting a roll until one of the gamepieces 60 is determined to be the winner. If a gamepiece 60 is determined to be the winner, the method 100 may proceed with the steps of 122 collecting by the dealer the base wagers associated with the gamepieces 60 not being the winner; 124 determining by the dealer the payout for each of the base wagers associated with the winner as the base wager times a payout multiplier; and 126 paying by the dealer the payout corresponding to each of the base wagers associated with the winner. According to an aspect, the dealer may move the winning gamepiece 60 to a specific location. As shown in FIG. 4, the specific location for the winning gamepiece 60 may be the corresponding betting position 64 within the infield area 62. According to an alternative aspect, the dealer may move the winning gamepiece 60 to the associated winner's position 58, which, as shown in FIG. 1, may be located between the first one 52 of the segments 50 and the last one 54 of the segments 50 of the lane 44 corresponding to the winning gamepiece 60.

According to an aspect, the method 100 may include the steps of 128 determining by the dealer the lead of the winning gamepiece 60 as the number of segments 50 behind the finish line 56 a second-place gamepiece 60 is located when the winning gamepiece 60 is determined to be the winner; and 130 determining by the dealer the payout multiplier from a first multiplier, which may be, for example 4:1 if the lead of the winning gamepiece 60 is less than a predetermined number of segments 50, which may be, for example 7 segments 50 or a second multiplier, which may be, for example 8:1 if the lead of the winning gamepiece 60 is greater than or equal to the predetermined number of segments 50.

As shown in the flowchart of FIG. 7, the method 100 may also include the optional steps of 132 placing by the player a side wager upon one of the gamepieces 60, which may be performed by, for example, placing a second wagering chip upon the first wagering chip used for the base wager; and 134 determining by the dealer if any of the side wagers are ineffective as having either no corresponding side wager of the same value and associated with a different gamepiece 60, or as having no corresponding side wager of the same value and associated with the winner; and 136 returning by the dealer to each associated player the side wagers that were determined to be ineffective. The optional steps of the method 100 may proceed with 138 determining by the dealer if any of the side wagers are effective as having a competing side wager which is of the same value and associated with a different gamepiece 60 and with one of the side wagers of the same value being associated with the winner; and 140 combining by the dealer all of the effective side wagers of a given value and associated with the gamepieces 60 not being the winner; and 142 distributing by the dealer all of the effective side wagers of the given value evenly between the side wagers of the given value and associated with the winner.

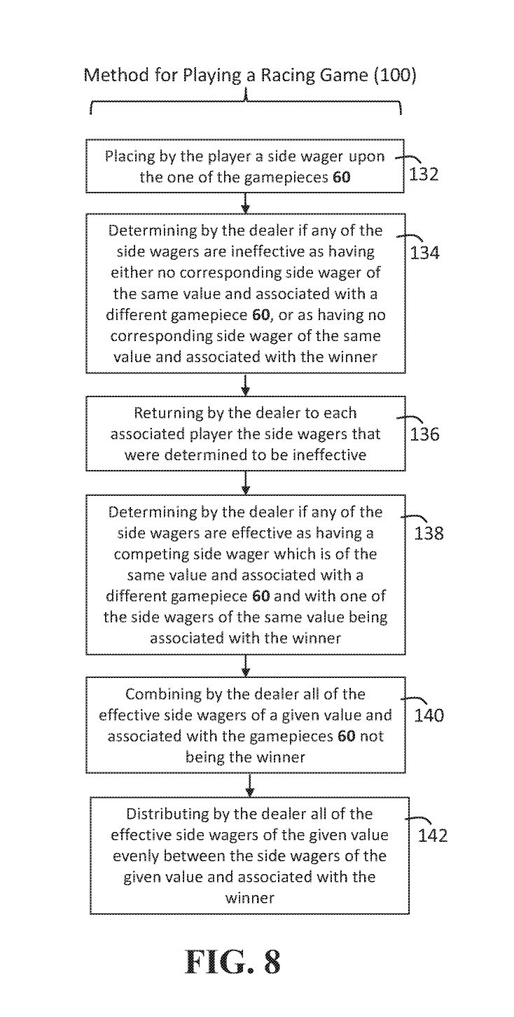

As shown in the flowchart of FIG. 8, an optional method 150 for a long-race wager may be combined with the method 100 for playing a racing game 20 of chance and may further comprise the steps of: 152 incrementing by the dealer a roll number indicator 38 for each roll that is conducted until one of the gamepieces 60 is determined to be the winner; 154 placing by a player a long-race wager; 156 collecting by the dealer the long-race wager if the number of rolls is less than a first predetermined number after the one of the gamepieces 60 is determined to be the winner; 158 determining by the dealer a long-race payout as a multiple of the long-race wager if the number of rolls in a race is greater than or equal to the first predetermined number. The long-race payout may be determined according to predetermined correlation, such as the paytable shown in Table 1, with a minimum multiple associated with the first predetermined number of rolls and higher multiples associated with a numbers of rolls greater than the first predetermined number; and 160 distributing by the dealer the long-race payout to the player.

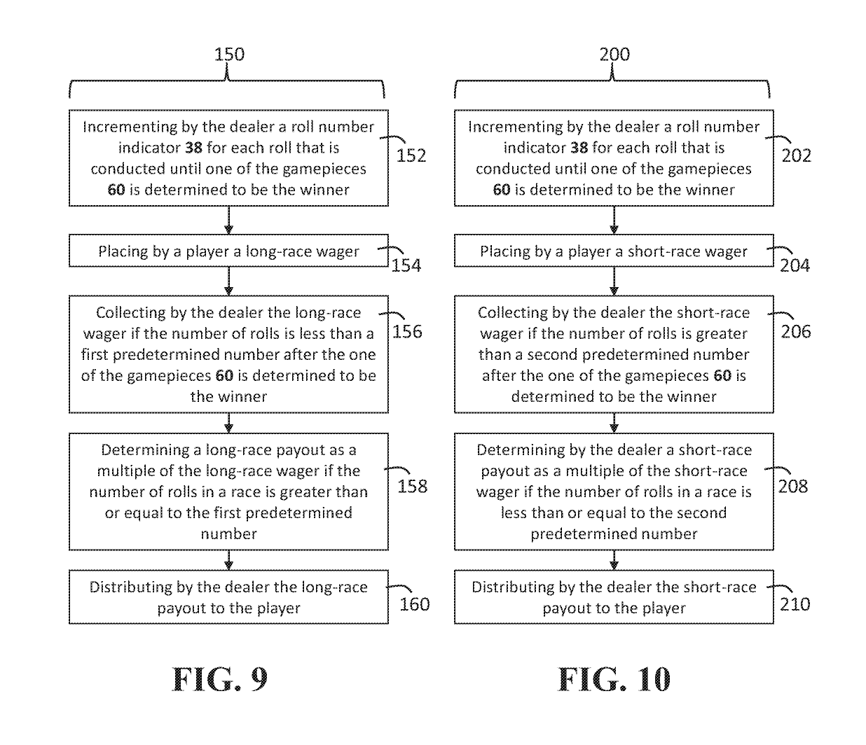

As shown in the flowchart of FIG. 9, an optional method 200 for a short-race wager may be combined with the method 100 for playing a racing game 20 of chance and may further comprise the steps of: 202 incrementing by the dealer a roll number indicator 38 for each roll that is conducted until one of the gamepieces 60 is determined to be the winner; 204 placing by a player a short-race wager; 206 collecting by the dealer the short-race wager if the number of rolls is greater than a second predetermined number after the one of the gamepieces 60 is determined to be the winner; 208 determining by the dealer a short-race payout as a multiple of the short-race wager if the number of rolls in a race is less than or equal to the second predetermined number. The short-race payout may be determined according to predetermined correlation such as the paytable shown in Table 2, with a minimum multiple associated with the second predetermined number of rolls and higher multiples associated with a numbers of rolls less than the second predetermined number; and 210 distributing by the dealer the short-race payout to the player.

Variations of the racing game 20 may be played without a dealer, such as, for example an electronic form or as dealer-assisted electronic table game, in which at least some of the methods steps which are performed by a dealer in a table game version are performed by a digital processor 80 and/or other equipment which may include a user input device 90 and a display screen and/or a projector.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In addition, the reference numerals in the claims are merely for convenience and are not to be read in any way as limiting.

What is claimed is:

1. A racing game comprising:
a race course including a plurality of lanes arranged generally concentrically and divided into a plurality of segments with each of said lanes having the same number of segments, and a finish line associated with a last one of said segments;
a gamepiece disposed upon and movable about each of said lanes in a race from an initial position upon a first one of said segments until one of said gamepieces first crosses said finish line and is thereby designated as a winning one of said gamepieces;
a first randomizer for determining a selected one of the gamepieces to be moved;
a second randomizer independent of said first randomizer for determining a number of segments said selected one of the gamepieces is to move;
a wagering area corresponding to each of said gamepieces for placement of a base wager; and
wherein said racing game provides a payout as a payout multiplier times each of said base wagers placed on said wagering area corresponding to said winning one of said gamepieces.

2. The racing game according to claim 1 further including a second place one of said gamepieces as one of said gamepieces other than said winning one of said gamepieces and which is closest to said finish line at the time that said winning one of said gamepieces crosses said finish line; and
wherein said winning one of said gamepieces has a lead as the number of segments that said second place one of said gamepieces is to said finish line; and
wherein said payout multiplier varies between two or more different values depending on said lead.

3. The racing game according to claim 1 further including a side wager being placed within said wagering area in addition to said base wager; and
wherein a given one of said side wagers placed on said wagering area corresponding to said winning one of said gamepieces is paid a portion of the total of all of said side wagers placed on said wagering areas not corresponding to said winning one of said gamepieces and having a value equal to said given one of said side wagers.

4. The racing game according to claim 1 wherein said gamepieces are stylized as racehorses.

5. The racing game according to claim 1 configured as a table game with
said race course disposed upon a playing surface with a dealer position and with a plurality of player positions.

6. The racing game according to claim 4 wherein at least one of said randomizers is a shuffler including a deck of cards.

7. The racing game according to claim 4 wherein at least one of said randomizers is a blower unit including a plurality of balls.

8. The racing game according to claim 4 wherein at least one of said randomizers includes one or more dice.

9. The racing game according to claim 1 wherein said racing game is configured as a dealer-assisted electronic table game comprising:
a digital reader for determining the result of each of said randomizers;
a projector for selectively illuminating a destination one of said segments where a selected one of said gamepieces is to move; and
a digital processor operatively disposed between said digital reader and said projector for directing said projector based on the state of the racing game and on the result of each of said randomizers in a given roll.

10. The racing game according to claim 1 wherein said racing game is configured as an electronic game comprising:
a display screen for presenting a video image of said race course and said gamepieces;
a user input device for allowing a player to interact with said racing game and to select one or more of said gamepieces to wager upon;
a digital processor operatively disposed between said user input device and said display screen for generating video image of said race course; and
wherein said randomizers include random number generators controlled by said digital processor.

11. The racing game according to claim 1 further comprising:
a roll number indicator for indicating a number of rolls of moving a selected gamepiece within one of said races; and
a long-race wagering area for allowing each player to place a long-race wager providing a long-race payout as a multiple of the long-race wager if the number of rolls in the race is greater than or equal to a first predetermined number and wherein said long-race payout varies according to the number of rolls completed in the race, and wherein the long-race payout provides a payout ratio that increases with a higher number of rolls.

12. The racing game according to claim 1 further comprising:
a roll number indicator for indicating the number rolls of moving a selected gamepiece within a race; and
a short-race wagering area for allowing each player to place a short-race wager providing a short-race payout as a multiple of the short-race wager as a multiple of the short-race wager if the number of rolls in the race is less than or equal to a second predetermined number and wherein said short-race payout varies according to the number of rolls completed in the race, and wherein the short-race payout provides a payout ratio that increases with a lower number of rolls.

13. A table game comprising:
a playing surface having a generally rectangular shape with four edges, said playing surface having a dealer position on one of said edges and with a plurality of player positions located about the remaining ones of said edges;
a race course on said playing surface and having a generally oval shape and including a plurality of lanes arranged generally concentrically with a plurality of radial lines dividing each of said lanes into an equal plurality of segments, with each of said lanes being marked with a first indicia;
a gamepiece disposed upon each of said lanes;
a first randomizer for determining a selected one of the gamepieces to be moved;
a second randomizer for determining a number of segments said selected one of the gamepieces is to move;
an infield area in the central area of said race course with a plurality of betting positons equal in number to said lanes and each having one of said first indicia matching a corresponding one of said lanes, and
an equal plurality of wagering areas adjacent each of said betting positons as the number of player positions with each of said wagering areas having a second indicia matching a corresponding one of said player positions.

14. A method for playing a game of chance comprising:
providing a race course including a plurality of lanes each divided into an equal plurality of segments and a gamepiece associated with each of said lanes;
placing by a player a base wager upon one of the gamepieces;
placing the gamepieces in an initial segment of the race course and with each of the gamepieces in an associated lane;
conducting a plurality of rolls until one of the gamepieces is determined to be the winner, the rolls each including the substeps of: selecting using a first randomizer a gamepiece to move, selecting using a second randomizer a number of segments the gamepiece is to move, and moving the gamepiece selected by the first randomizer by a number of segments as indicated by the second randomizer;
determining after a roll is complete whether the selected gamepiece is a winner having moved beyond a finish line on the race course;
determining the payout for each of the base wagers associated with the winner as the base wager times a payout multiplier;
collecting the base wagers associated with the gamepieces not being the winner; and
distributing the payout corresponding to each of the base wagers associated with the winner.

15. The method for playing a game of chance according to claim 14 and further comprising:
wagering by the player a side wager upon the one of the gamepieces;
determining if any of the side wagers are ineffective as having either no corresponding side wager of the same value and associated with a different gamepiece, or as having no corresponding side wager of the same value and associated with the winner;
determining if any of the side wagers are effective as having both a side wager of the same value and associated with a different gamepiece and a side wager of the same value associated with the winner;
returning to each associated player the side wagers that were determined to be ineffective;
combining all of the effective side wagers of a given value and associated with the gamepieces not being the winner and distributing all of the effective side wagers of the given value evenly between the side wagers of the given value and associated with the winner.

16. The method for playing a game of chance according to claim 14 and further comprising:
determining the lead of the winning gamepiece as the number of segments behind the finish line a second-place gamepiece is located when the winning gamepiece is determined to be the winner;
determining the payout multiplier as one of two or more different values depending on the lead of the winning gamepiece.

17. The method for playing a game of chance according to claim 14 and further comprising:
incrementing a roll number indicator for each roll that is conducted until one of the gamepieces is determined to be the winner;
placing by a player a long-race wager;
collecting the long-race wager if the number of rolls is less than a first predetermined number after the one of the gamepieces is determined to be the winner;
determining a long-race payout as a multiple of the long-race wager if the number of rolls in a race is greater than or equal to the first predetermined number, wherein the long-race payout is determined according to predetermined correlation with a minimum multiple associated with the first predetermined number of rolls and higher multiples associated with a numbers of rolls greater than the first predetermined number; and
distributing the long-race payout to the player.

18. The method for playing a game of chance according to claim 14 and further comprising:
incrementing a roll number indicator for each roll that is conducted until one of the gamepieces is determined to be the winner;
placing by a player a short-race wager;
collecting the short-race wager if the number of rolls is greater than a second predetermined number after the one of the gamepieces is determined to be the winner;
determining a short-race payout as a multiple of the short-race wager if the number of rolls in a race is less than or equal to the second predetermined number, wherein the short-race payout is determined according to predetermined correlation with a minimum multiple associated with the second predetermined number of rolls and higher multiples associated with a numbers of rolls less than the second predetermined number; and
distributing the short-race payout to the player.
